(19) United States
(12) Patent Application Publication
(10) Pub. No.: US 2005/0144028 A1
(43) Pub. Date: Jun. 30, 2005

(54) Methods and apparatus for network-based property management

(76) Inventors: Thomas E. Donahue, Scottsdale, AZ (US); Jeffrey J. Krajewski, Scottsdale, AZ (US); Jeffrey M. Stull, Tempe, AZ (US)

Correspondence Address: Daniel R. Pote;SNELL & WILMER LLP, One Arizona Center, 400 East Van Buren, Phoenix, AZ, 85004-2202, US

(21) Appl. No.: 10/750,274

(22) Filed: Dec. 31, 2003

(51) Int. Cl. G06F 17/60

(52) U.S. Cl. 705/1

(57) ABSTRACT

A property management system includes a tenant system associated with a tenant residing at the rental property, an owner system associated with an owner of the rental property, and a plurality of provider systems, wherein each of the provider systems is associated with a provider configured to provide goods or services to a tenant and/or the rental property. The tenant system, owner system, and provider systems are all configured to communicate over a network (e.g., the Internet). A property management system, also coupled to the network, is configured to communicate with the various systems and to coordinate an income stream from the tenant to the owner. The income stream has two components: one component (a traditional income stream) derived from a rental obligation of the tenant, and a second income stream (a non-traditional income stream) is derived from the property management system's coordination of the plurality of providers in response to a request received from the tenant system. The ratio of income received by the owner from the traditional component is preferably much smaller than that received via the non-traditional component, preferably less than half, and most preferably about zero.

### FIELD OF INVENTION

The present invention relates, generally, to the management of rental properties and, more particularly, to an improved network-based property management system.

### BACKGROUND OF THE INVENTION

Traditionally, rental properties generate income for their owners exclusively through tenant rent payments. The property owner's activities with respect to the property are merely reactive; that is, when the tenant or property has a problem, or when maintenance is required, the property owner attempts to schedule the required repairs through a contractor or the like. The task might be completed satisfactorily, or it may not. The owner will typically not have any visibility with respect to the process, and will generally not know whether the response was timely, cost-efficient, or even performed correctly. This is especially true with commercial rental properties.

Furthermore, because of the open-looped, reactive nature of the traditional owner-tenant relationship, the owner is typically not in a position to add value to the tenants in the form of goods and services. That is, the tenant contracts with third parties for telephone service, Internet connectivity, electricity, and the like. The owner is not involved with the provisions of these services, and can not derive any benefit from the selection of providers.

While recent advances in networked communications have led to an increase in web-based interaction between tenants and owners, the nature of these interactions are such that they do not impact on the traditional role of the property owner, who must satisfy himself with an income stream derived entirely from the traditional source—i.e., the payment of rent.

### SUMMARY OF THE INVENTION

The present invention overcomes the limitations of the prior art by providing an innovative system for network-based management of a rental property. In accordance with one embodiment of the present invention, a property management system includes a tenant system associated with a tenant residing at the rental property, an owner system associated with an owner of the rental property, and a plurality of provider systems, each of the provider systems associated with a provider configured to provide goods or services to a tenant and/or rental property. The tenant system, owner system, and provider systems are all configured to communicate over a network (e.g., the Internet). A property management system, also coupled to the network, is configured to communicate with the various systems and to coordinate an income stream from the tenant to the owner. The income stream includes two components: one component (a traditional income stream) derived from a rental obligation of the tenant, and a second income stream (a non-traditional income stream) derived from the property management system's coordination of the plurality of providers in response to a request received from the tenant system. The ratio of income received by the owner from the traditional component is preferably much smaller than that received via the non-traditional component, preferably less than half, and most preferably about zero.

The property management system includes various modules configured to interface with the tenant and/or the owner, including, for example, a repair request module, a tenant concierge services module, a preventative maintenance module, an inspections module, a purchase order module, an inventory module, a tenant communications module, a third party property information module, and/or a brokerage services module.

In accordance with one aspect of the present invention, the work order system includes an automatic-assignment component providing artificial intelligence in the form of a weighting system configured to prioritize work-order completion.

In accordance with another aspect of the present invention, a tactical display is provided for visualizing and coordinating the location of service personnel with respect to the location of properties to be serviced. This tracking may be accomplished, for example, via GPS-enabled cell-phones carried by service personnel.

### BRIEF DESCRIPTION OF THE DRAWINGS

The subject invention will hereinafter be described in conjunction with the appended drawing figures, wherein like numerals denote like elements, and:

FIG. 1 is a schematic, conceptual overview of a networked property management system in accordance with the present invention;

FIGS. 2A and 2B depict a process in accordance with one aspect of the present invention, superimposed on the system of FIG. 1;

FIG. 3 is an exemplary property management system, showing, conceptually, a collection of databases and functional modules;

FIG. 4 is a flowchart of an exemplary repair request method in accordance with one aspect of the present invention;

FIG. 5 is an example user interface for use in connection with a repair request module in accordance with the present invention; and

FIG. 6 depicts a tactical display in accordance with one embodiment of the present invention.

### DETAILED DESCRIPTION

The present invention generally provides an improved network-based property management system. In this regard, the present invention may be described in terms of functional block components, network diagrams, and various processing steps. It should be appreciated that such functional blocks may be realized by any number of hardware and/or software components configured to perform the specified functions. In addition, those skilled in the art will appreciate that the present invention may be practiced in any number of data communication contexts and that the various systems described herein are merely exemplary applications for various aspects of the invention. Further, it should be noted that the present invention may employ any number of conventional techniques for data transmission, training, signal processing and conditioning, and the like. Such general techniques and components are known to those skilled in the art are not described in detail herein.

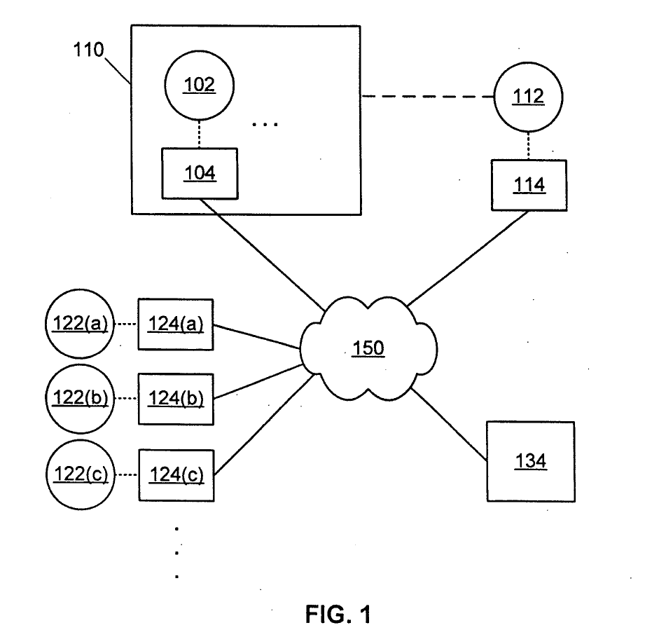

With reference to the conceptual diagram shown in FIG. 1, a system in accordance with one embodiment of the present invention includes at least one tenant system 104 associated with a tenant 102 residing or otherwise associated with a rental property 110. Similarly, an owner system 114 is associated with an owner 112 of rental property 110, and a plurality of provider systems 124 are associated with corresponding providers 122 that are configured to provide goods or services to tenant 102 and/or rental property 110. Tenant system 104, owner system 114, and provider systems 124 are all configured to communicate with each other over a network 150 (e.g., the Internet). A property management system 134, also coupled to network 150, is configured to communicate with the various systems and to coordinate an income stream from tenant 104 to owner 112. The income stream has two components: one component (a traditional income stream) derived from a rental obligation of tenant 102, and a second income stream (a non-traditional income stream) derived from the tenants dependence on property management system 134 and its coordination of plurality of providers 122 in response to a request received from tenant system 104. The nature of this request will be described in further detail below, but generally speaking, the request may encompass any number of value-added services, including repair requests, concierge requests, brokerage services, banking services, and the like. The ratio of income received by the owner from the traditional component is preferably much smaller than that received via the non-traditional component, preferably less than half, and most preferably about zero. The traditional component, e.g., rental income, is preferably collected automatically from tenant 102 via a suitable e-commerce module.

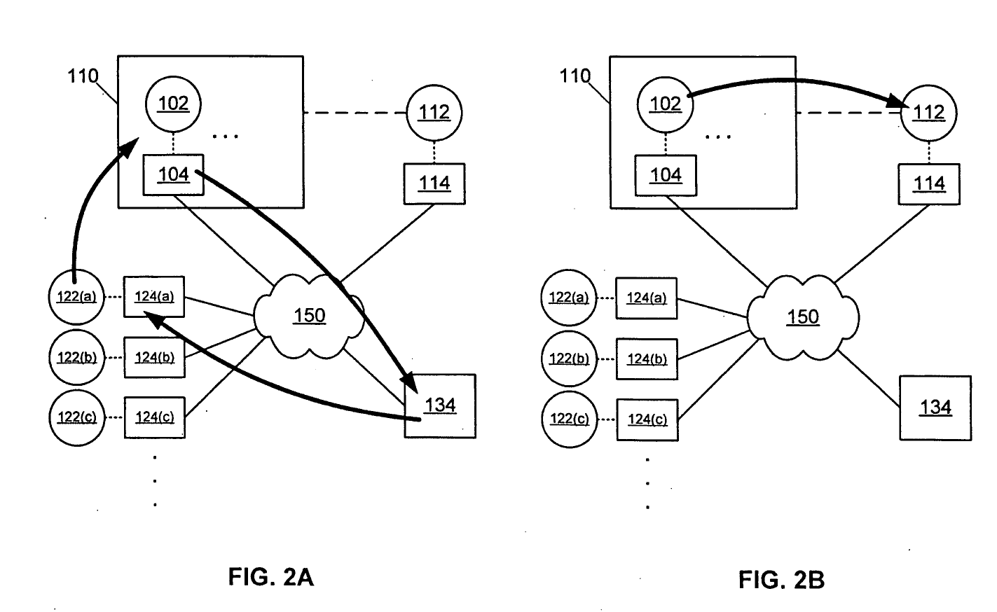

For example, referring to FIG. 2A, a tenant 102 of property 110 utilizes tenant system 104 to submit, lodge, or otherwise communicate some form of request (e.g., a service request) to system 134 over network 150 (e.g., via a web-based user-interface accessible over the Internet). This request is stored and suitably processed by, for example, communicating with a provider system 124(a) associated with a provider 122 and arranging for fulfillment of the request. Provider system 124(a) suitably coordinates with tenant 102 to complete the request, after which various notifications and back-end processing may take place.

As mentioned above, and as illustrated in FIG. 2B, tenant 102 will likely have a rental obligation vis-a-vis owner 112. At the same time, due to the provision of services through system 134 as outlined above, tenant 102 will have additional payment obligations, resulting in an income stream based largely on the added value provided by system 134. The ratio of income received by the owner from the traditional component is preferably much smaller than that received via the non-traditional component.

Tenant system 104, owner system 114, and provider systems 124 may include any convenient combination of hardware and software components configured to allow an individual to review, configure, and/or communicate the request information over network 150. For example, tenant system 104 might include a standard personal computer (PC) comprising a CPU, monitor, storage, keyboard, mouse, and communication hardware appropriate for the given data link 104 (e.g., V.90 modem, network card, cable modem, ISDN connection, etc.). Tenant system 104 might also include one or more peripheral devices such as a scanner, a printer, a digital camera, a motion video camera, or the like.

As those skilled in the art will appreciate, tenant system 104 will typically include an operating system (e.g., Windows XP/NT, Linux, Solaris, etc.) as well as various conventional support software and drivers typically associated with such computers. Tenant system 104 also preferably includes application software configured to communicate over network 150 with system 134, for example, a WWW browser such as Microsoft Internet Explorer, or any other present or future communication software that operates in accordance with the HTML and HTTP protocols.

In an alternate embodiment, tenant system 104 is a personal data assistant (PDA) having sufficient browser software for communicating with system 134. In yet another embodiment, tenant system 104 is a kiosk located, for example, at a designated location on property 110.

As the present invention is best deployed in the context of a property management system 134 having a number of tenants 102 and third-party providers 122, network preferably corresponds to the Internet. As used herein, the term “Internet” refers to the global, packet-switched network utilizing the TCP/IP suite of protocols. Nevertheless, the present invention may be implemented in other wired or wireless network contexts, including any future alternatives to the Internet, as well as other suitable “internetworks” based on other open or proprietary protocols.

A variety of conventional communications media and protocols may be to connect the various systems. Such links might include, for example, a connection to an Internet Service Provider (ISP) over the local loop as is typically used in connection with standard modem communication, or cable modems, Dish networks, ISDN lines, Digital Subscriber lines (xDSL), or a variety of wireless communication schemes. Tenant system 104 might also reside within a local area network (LAN) associated with property 110 which interfaces to network 150 via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

Specific information related to the protocols, standards, and application software utilized by in connection with the Internet will not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

Providers 122 may include any third party capable of providing goods and services. Without limitation, such providers include entities capable of providing the tenant with Internet connectivity, telephone service, cable television service, utilities, legal services, office supplies, dry cleaning, and the like.

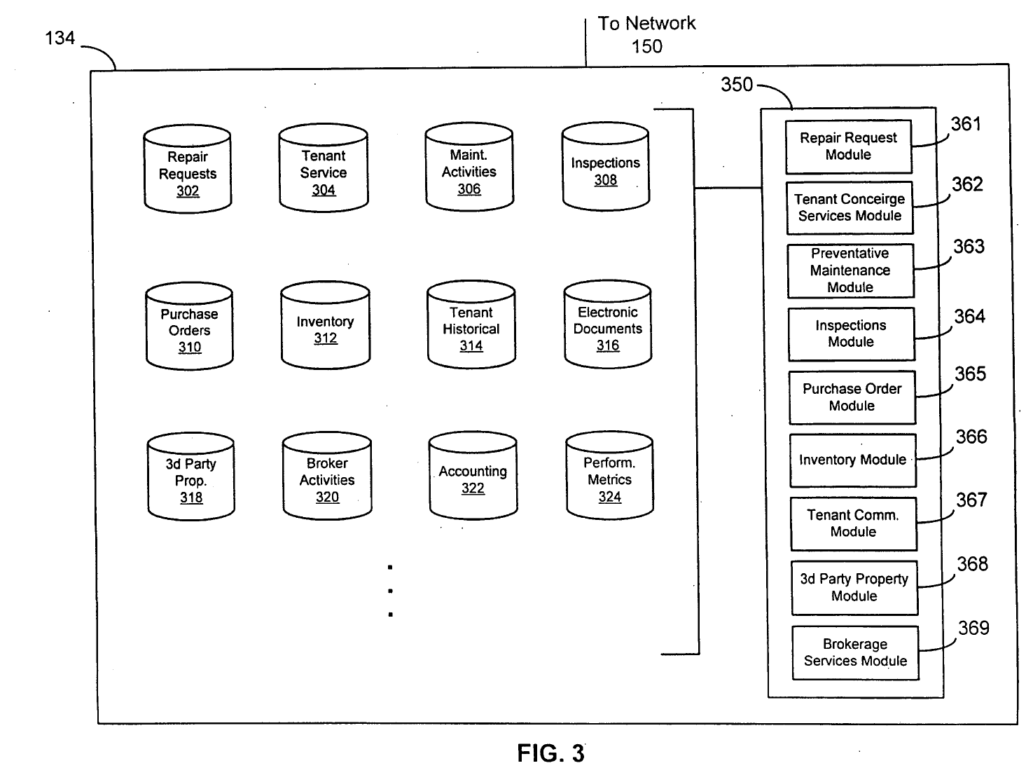

Referring to FIG. 3, property management system 134 comprises any number of hardware, software, and networking components such as servers, routers, fire-walls, and the like, and also includes various software/hardware modules (361-369) and databases (302-324) configured to interface with the tenant and/or the owner to provide the desired services. In the preferred embodiment, system 134 includes a web service providing a suitable website or other Internet-based graphical user interface that is accessible by tenant 102 via tenant system 104, and which provides the functionality described in further detail below. In this regard, the term “web page” as used herein is not meant to limit the type of documents and applications that might be used to interact with the user. For example, a typical website might include—in addition to standard HTML documents—various forms, Java applets, Javascript, active server pages (ASP), common gateway interface scripts (CGI), extensible markup language (XML), dynamic HTML, cascading style sheets (CSS), helper applications, plug-ins, and the like.

Databases 302-324 may be physically proximate (but logically separate) with respect to each other, or may be distributed in any convenient fashion. The system as illustrated in FIG. 3 is merely conceptual, and is not intended to limit the hardware or software configuration that may be used in connection with the present invention.

System 134 preferably includes one or more of the following databases: a repair request database 302, a tenant services database 304, a maintenance activities database 306, inspections database 308, a purchase orders database 310, an inventory database 312, a tenant historical database 314, an electronic documents database 316, a 3rd party property database 318, a broker activities database 320, an accounting database 322, and a performance metrics database 324.

Similarly, as shown, system 134 preferably includes one or more of the following modules: a repair request module 361, a tenant concierge services (or simply “concierge”) module 362, a preventative maintenance (or “PM”) module 363, an inspections module 364, a purchase order (or “PO”) module 365, an inventory module 366, a tenant communications (or “communications”) module 367, a third-party property (“3d party”) module 368, and a brokerage services (or “brokerage”) module 369.

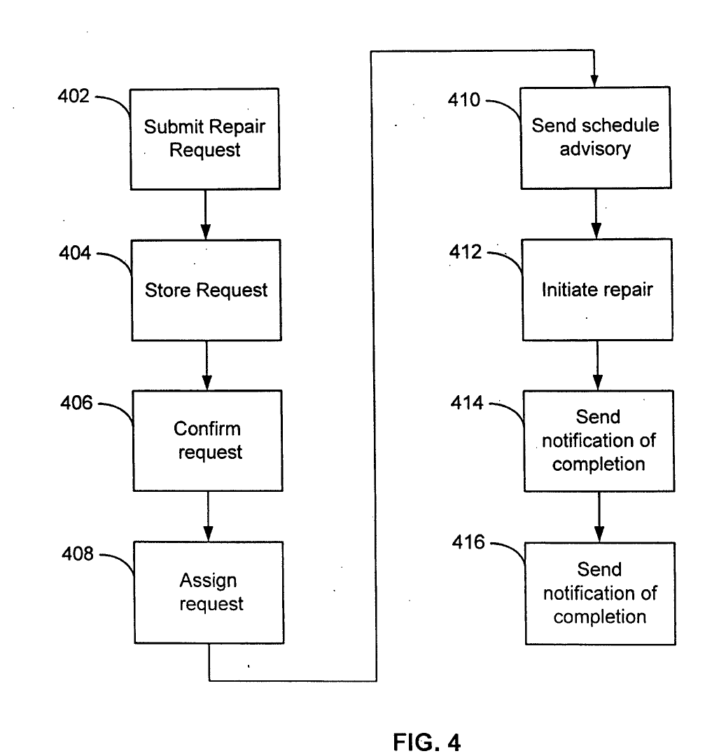

Referring to the flowchart shown in FIG. 4 in conjunction with the system overview shown in FIG. 1, an example repair request module 361 operates as follows. First, in step 402, the tenant 102 utilizes tenant system 104 to submit a repair request to property management system 134. System 134 suitably stores the request (step 404), then preferably sends a confirmation of this request (e.g., via an e-mail acknowledgment) to tenant 102 (step 406). System 134 then assigns this request to the appropriate third party provider or providers 122 (step 408).

System 134 communicates with provider systems 124 (e.g., via e-mail, web-page update, PDA, pager, or the like) in step 408, then sends a scheduling advisory to tenant 102 (step 410). The scheduling advisory preferably notifies and/or negotiates with tenant 102 re desirable times for the requested repairs to take place.

The provider 122 then initiates the repair (step 412) and, if the task is suitably completed (or otherwise addressed or disposed of), a notification of completion is sent to tenant 102 (step 414). Any or all of these steps may be performed by communicating directly with the provider via a PDA or pager device that allows the provider to update the owner and/or tenant regarding the status of the work request.

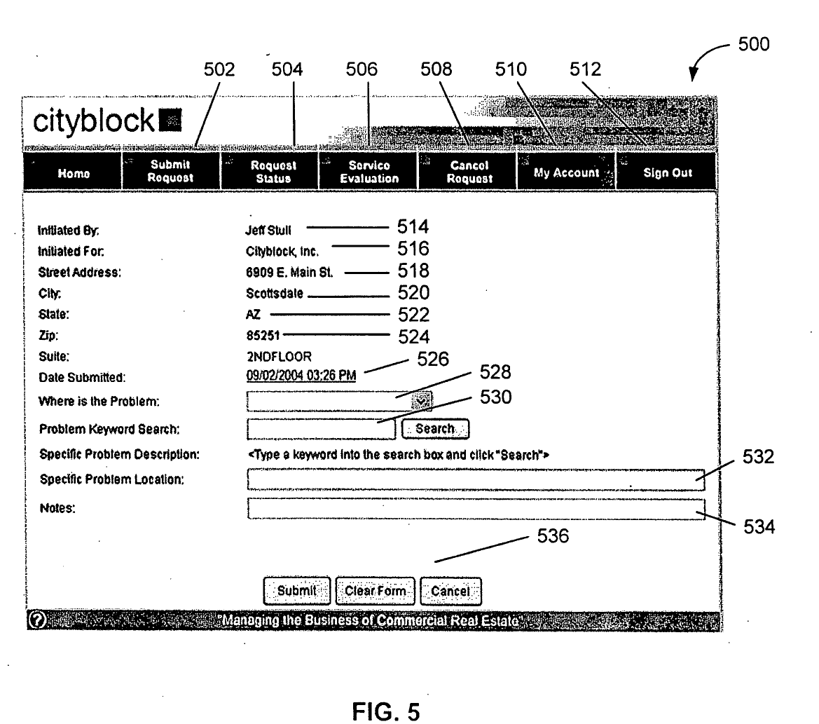

FIG. 5 shows an example web-based user interface configured to acquire a tenant work request. As shown, a web page 500 includes a series of button or other hyperlinks functioning to submit a request (502), track request status (504), evaluate the service (506), cancel a request (508), view account information (510), and sign out (512). The web page 500 also includes a number of fields for entering data related to the requested service. For example, in the illustrated embodiment, the tenant enters initiator data 514, property (or organization) information 516, address information 518-524, submission date 526, location of the problem 528, problem keyword search field 530 (optional), specific problem location 532, and notes 534. Various additional navigation keys or hyperlinks may also be included (e.g., “submit,” “clear form,” and “cancel,” buttons 536).

It will be appreciated that various fields in page 500 may be automatically populated as a result of known log-in information (i.e., name, address, etc.), selected from drop down menus, selected as a result of a search (field 530), or simply entered as alphanumeric data via a keyboard. Furthermore, It will be appreciated that the layout and content of FIG. 5 is not intended to limit the range of possible page designs applicable to the present invention.

After the aforementioned repair request process is concluded, the system might also engage in a number of additional administrative and/or record-keeping functions. For example, referring to FIG. 3, materials inventory transactions may be recorded via inventory module 366 and inventory database 312. Similarly, the scheduling and turn-around-time of the repair request may be tracked by performance metrics database 324. Furthermore, the labor and materials involved in the repair are preferably processed by a suitable accounting system used in connection with accounting database 322.

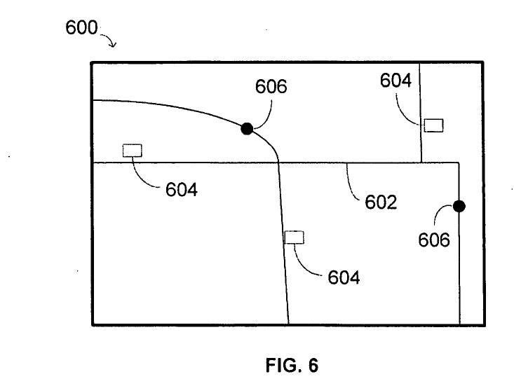

In accordance with a further embodiment of the present invention, the repair request system incorporates a tactical display component, a GPS-enabled phone component, and/or an automatic work-order assignment component. That is, referring now to FIG. 6, a tactical display 600 generally includes a variety of map features 602 used to visualize, in substantially real-time, the location of service personnel (or simply “personnel”) 606 with respect to the various properties 604. Suitable icons are used to designate service personnel 606 and properties 604, and map features 602 may include a wide range of conventional map iconography, including streets, highways, rivers, lakes, geological features, political boundaries, buildings, and any other appropriate features.

Tactical display 600 preferably provides a user interface allowing scaling, zooming, panning, and re-centering of the display. Furthermore, using tactical display 600, an individual (e.g., the system manager) may monitor and coordinate the location of personnel 606 and gauge the progress of assigned work orders (discussed below). That is, the user may select individual properties 604 and personnel 606 and interrogate the status of that property or personnel.

In this regard, the GPS-enabled phone component (GCPC) comprises suitable hardware and software capable of providing location-reporting as well as a technician user interface. Each service personnel preferably travels with a GCPC. The GCPC sends information specifying the location of that service personnel at predetermined intervals though a suitable network (e.g., the Internet). For example, the GCPC may transmit longitude, latitude, altitude, speed, and direction of travel. Using this information, the system can display service personnel locations on tactical display 600 and determine the availability of that personnel for work order assignments. All or a portion of this information may be shared with the tenant.

GCPC preferably also includes a technician user interface that allows the work order scheduling module to communicate with service personnel. For example, work orders are preferably assigned via the GCPC (e.g., a cell-phone display), by transmitting to the service personnel information specifying work-order problem reported, work order location, and tenant contact information. Similarly, service personnel may accept, suspend, and complete work order assignments through the technician user interface.

As mentioned above, the work order processing system preferably includes an auto-assignment component. The purpose of this auto-assignment component is to provide a level of artificial intelligence that mimics to a large extent the human decision-making process used to assign work orders requested by tenants.

In accordance with one aspect of this invention, the auto-assignment component uses a heuristic weighting system. Specifically, each work order is assigned a numerical “weight value” used to prioritize that work order. Defined (static) and dynamic weighting terms may be used. Static terms may include, for example, the “work order open” state. If this state or condition is met, a static numeric value is added to or subtracted from the running total assigned to the work order. A dynamic term, on the other hand, may be used to add or subtract a set value to or from the object's weight based on a cumulative or re-occurring event, such as “every hour the work order is waiting to be serviced.”

The result of this weighting process is that, at any given time, certain objects (work orders) are “heavier,” while others are “lighter.” These “heavier” objects are given higher priority, and are therefore preferably assigned quicker and/or scheduled for completion earlier.

Management personnel may be allowed to modify to some extent the weighting of individual work orders in order to accelerate or delay servicing of a work order. However, these adjustments are preferably done through the weighting system, rather than by circumventing it. This will prevent user-weighted values from monopolizing available resources and eviscerating the artificial intelligence component.

It will be appreciated that this invention contemplates any number of different weighting processes based on a variety of factors. For example, property locations and service personnel may be assigned weighting criteria, and factors such as current personnel location, technician skill set, available inventory, and the like, may be used to adjust the cumulative weight of a given work order.

Concierge module 362 includes suitable software and hardware configured to provide cost-effective services and/or goods to tenant 102 via one or more providers 122 using leveraged pricing, etc. Such services might include, for example, Internet connectivity, equipment financing, purchase of office supplies, equipment financing, employee fringe benefits programs (e.g., “loyalty” programs associated with the property), telephone services, employee leasing, utilities, or any other such product or service. The tenant 102 preferably receives a single electronic bill each month for all concierge services as well as rent.

This module operates in a manner similar to that described above in connection with repair request module 361. That is, tenant 102 communicates with system 134 to register for additional services (e.g., on-line banking, etc.). The registration information is stored within tenant services database 304. System 134 then coordinates with providers 122 to supply tenant 102 with the desired goods or services.

Because owner 112 preferably handles a large number of tenants 102, the traditional economy of scale can be brought to bear, and the resulting savings can be passed on to tenant 102 and/or provide a portion of the second, non-traditional income stream component. Financial transactions are preferably coordinated with accounting database 322. Tenant satisfaction surveys related to these services may be provided to tenants 102 (e.g., via a web-based form), with the results being stored in performance metrics database 324.

Preventative maintenance module 363 includes suitable hardware and software for scheduling maintenance of the property. This module, as with many of the modules, is preferably only accessible by owner 112 (and not tenant 102). With this module, owner 112 may query and populate maintenance activities database 306 such that the module can automatically schedule certain weekly, monthly, or common tasks. That is, activities may be queued and submitted to tenant repair request module 361 automatically (bypassing the user interface), and the desired repairs or tasks can be completed in due course. Similarly, inspections module 364 includes suitable hardware and software configured to schedule inspections of the property, and works in conduction with inspections database 308. These modules preferably interface with accounting database 322 and performance metrics database 324.

Purchase order module 365 includes suitable hardware and software (including purchase order database 310) configured to allow purchase orders to be processed by the various departments and entities associated with the property owner. This module suitably interfaces with inventory module 366 to coordinate shipping/receiving, etc., and also interfaces with accounting database 322.

Tenant communication module 367 tracks tenant data in conjunction with tenant historical database 314. A tenant services representative associated with the property owner communicates over the Internet to archive personnel & system-generated communications. Such documents might be stored in electronic documents database 316.

Third party property module 368 provides a sales and marketing function and, in conjunction with 3rd party property database 318, targets new tenancy and property ownership. Real estate brokerage services module 369 and broker activities database 320 drive leasing of the properties. The efficacy of these activities are tracked and reported to the property owner.

In summary, what has been provided is an improved, networked-based property management system employing various software modules. Each of the various modules described above act together to add value, provide goods and services to the tenant, and consequently increase the proportion of non-traditional income (and reduce the proportion of lease-related income) provided to the owner.

That is, the income stream from tenant to owner has two components: one component (a traditional income stream) derived from a rental obligation of the tenant, and a second income stream (a non-traditional income stream) is derived from the property management system's coordination of the plurality of providers in response to a request received from the tenant system. The ratio of income received by the owner from the traditional component is preferably much smaller than that received via the non-traditional component, preferably less than half, and most preferably about zero. This ratio is driven by a number of factors, including whether and to what extent the tenant registers for the various concierge services.

Although the invention has been described herein in conjunction with the appended drawings, those skilled in the art will appreciate that the scope of the invention is not so limited. Modifications in the selection, design, and arrangement of the various components and steps discussed herein may be made without departing from the scope of the invention as set forth in the appended claims.

1. A system for managing a rental property, said system comprising:
a tenant system associated with a tenant residing at the rental property, said tenant system coupled to a network;
an owner system associated with an owner of the rental property, said owner system coupled to said network;
a plurality of provider systems coupled to said network, each of said provider systems associated with a provider configured to provide goods or services to said tenant and/or said rental property;
a property management system coupled to said network and configured to communicate with said tenant system, said owner system, and said plurality of provider systems over said network;
said property management system configured to coordinate an income stream from said tenant to said owner, said income stream having a first component and a second component, wherein said first component of said income stream is derived from a rental obligation of said tenant, and said second component of said income stream is derived from said property management system's coordination of said plurality of providers in response to a request received from said tenant system.

2. The system of claim 1, wherein said second component of said income stream is greater than said first component of said income stream.

3. The system of claim 1, wherein the fraction of said first component to said second component of said income stream is less than approximately 0.5.

4. The system of claim 1, wherein the fraction of said first component to said second component of said income stream is approximately zero.

5. The system of claim 1, wherein said property management system includes a tenant repair request module.

6. The system of claim 1, wherein said tenant repair request module is configured to:
receive, over said network, an electronic repair request from said tenant system;
send, over said network, a receipt confirmation to said tenant system reflecting the receipt of said repair request;
coordinate, over said network, with said plurality of providers to schedule initiation of a service responsive to said repair request;
send, over said network, a completion confirmation to said tenant system reflecting completion of said service.

7. The system of claim 6, further including a handheld wireless device configured to allow one of said providers to transmit said completion confirmation to said property management system.

8. The system of claim 6, wherein said tenant repair request module communicates with a materials inventory system.

9. The system of claim 6, wherein said tenant repair request module is configured to communicate with an accounting system.

10. The system of claim 6, wherein said tenant repair request module is configured to communicate with a performance metrics module.

11. The system of claim 5, wherein said tenant repair request module includes a tactical display component configured to display map features, the location of service personnel, and the location of at least one of said rental properties.

12. The system of claim 5, wherein said tenant repair request module includes a GPS-enabled phone component.

13. The system of claim 5, wherein said tenant repair request module includes an automated work-order assignment component.

14. The system of claim 13, wherein said automated work-order assignment component is configured to provide a heuristic weighting system wherein each work order is assigned a weight value, and that weight value has a static and a dynamic component.

15. The system of claim 1, wherein said property management system includes a tenant concierge services module.

16. The system of claim 1, wherein said property management system includes an administrative module accessible over said network by said owner, said administrative module including at least one of: a preventative maintenance module, an inspections module, a purchase order module, an inventory module, a tenant communications module, and a third party property information module.

17. The system of claim 1, wherein said property management system includes a brokerage services module.

18. The system of claim 1, wherein said network is a packet-switched network.

19. The system of claim 18, wherein said network is the Internet.

20. The system of claim 1, wherein said tenant system includes an Internet browser and said property management system includes a world-wide web service configured to communicate with said tenant system via Hypertext Transport Protocol.

21. A method for managing a rental property, said method comprising the steps of:
providing a tenant system associated with a tenant residing at the rental property, said tenant system configured to communicate with an owner system and a provider system over a network, wherein said owner system is associated with an owner of the rental property, and said provider system is associated with a provider configured to provide goods or services to said tenant and/or said rental property;
providing a property management system coupled to said network and configured to communicate with said tenant system, said owner system, and said plurality of provider systems over said network;
coordinating an income stream from said tenant to said owner, said income stream having a first component and a second component, wherein said first component of said income stream is derived from a rental obligation of said tenant, and said second component of said income stream is derived from said property management system's coordination of said plurality of providers in response to a request received from said tenant system.

22. The method of claim 21, wherein said step of coordinating an income stream includes provision of said second component such that said second component is greater than said first component of said income stream.

23. The method of claim 21, wherein said step of coordinating an income stream includes provision of said second component such that the fraction of said first component to said second component of said income stream is less than approximately 0.5.

24. The method of claim 21, wherein said step of coordinating an income stream includes provision of said second component such that the fraction of said first component to said second component of said income stream is approximately zero.

25. The method of claim 21, wherein said step of providing a property management system includes providing a tenant repair request module configured to:
receive, over said network, an electronic repair request from said tenant system;
send, over said network, a receipt confirmation to said tenant system reflecting the receipt of said repair request;
coordinate, over said network, with said plurality of providers to schedule initiation of a service responsive to said repair request; and
send, over said network, a completion confirmation to said tenant system reflecting completion of said service.

26. The system of claim 25, wherein said tenant repair request module includes a tactical display component configured to display map features, the location of service personnel, and the location of at least one of said rental properties.

27. The system of claim 25, wherein said tenant repair request module includes a GPS-enabled phone component.

28. The system of claim 25, wherein said tenant repair request module includes an automated work-order assignment component.

29. The system of claim 28, wherein said automated work-order assignment component is configured to provide a heuristic weighting system wherein each work order is assigned a weight value, and that weight value has a static and a dynamic component.

30. The method of claim 25, further including the step of providing a handheld wireless device configured to allow one of said providers to transmit said completion confirmation to said property management system.

31. The method of claim 25, wherein said tenant repair request module communicates with a materials inventory system.

32. The method of claim 25, wherein said tenant repair request module communicates with an accounting system.

33. The method of claim 25, wherein said tenant repair request communicates with a performance metrics module.

34. The method of claim 25, wherein said property management system includes a tenant concierge services module.

35. The method of claim 25, wherein said property management system includes an administrative module accessible over said network by said owner, said administrative module including at least one of: a preventative maintenance module, an inspections module, a purchase order module, an inventory module, a tenant communications module, and a third party property information module.

36. The method of claim 25, wherein said property management system includes a brokerage services module.

37. The method of claim 25, wherein said network is a packet-switched network.

38. The system of claim 37, wherein said network is the Internet.

39. The system of claim 1, wherein said tenant system includes an Internet browser and said property management system includes a world-wide web service configured to communicate with said tenant system via Hypertext Transport Protocol.

40. A property management platform for managing a rental property having an owner and a tenant associated therewith, said platform comprising:
a server configured to communicate over a network with the owner, the tenant, and a plurality of providers configured to provide goods or services to the tenant and/or the rental property;
a database operatively coupled to said server;
a software suite configured to coordinate an income stream from the tenant to the owner, said income stream having a first component and a second component, wherein said first component of said income stream is derived from a rental obligation of the tenant, and said second component of said income stream is derived from the coordination of said plurality of providers in response to a request received from the tenant.

41. The system of claim 40, wherein said second component of said income stream is greater than said first component of said income stream.

42. The system of claim 40, wherein the fraction of said first component to said second component of said income stream is less than approximately 0.5.

43. The system of claim 40, wherein the fraction of said first component to said second component of said income stream is approximately zero.

44. The system of claim 40, wherein said software suite includes a tenant repair request module.

45. The system of claim 40, wherein said software suite includes a tenant concierge services module.

46. The system of claim 40, wherein said software suite includes an administrative module accessible over said network by said owner, said administrative module including at least one of: a preventative maintenance module, an inspections module, a purchase order module, an inventory module, a tenant communications module, and a third party property information module.

47. The system of claim 40, wherein said software suite includes a brokerage services module.

48. The system of claim 40, wherein said software suite interfaces with an accounting database.

49. A computer-implemented method of managing a rental property having an owner, a tenant, and a plurality of third-person providers associated therewith, said method comprising the steps of:
defining a set of value drivers, wherein each of said value drivers is defined as either a direct value driver or an indirect value driver;
facilitating an income stream from the tenant to the owner, said income stream having a first component and a second component, wherein said first component of said income stream is derived from said direct value drivers, and said second component of said income stream is derived from said indirect value drivers.

50. The method of claim 49, wherein said set of direct value drivers includes rent payment and operating costs, and said indirect value drivers includes a process efficiency metric associated with the coordination of said third-person providers vis-à-vis the property and the tenant.

51. The method of claim 50, wherein said process efficiency metric is increased by providing the tenant with a software module selected from the group consisting of an electronic banking module, an automated work-order module, a tenant concierge module, and an on-line leasing module.

52. The method of claim 50, wherein said set of indirect value drivers further includes a quality control metric.

53. A method of increasing the value of a rental property having an owner and a tenant associated therewith, said method comprising the steps of:
defining a baseline value of the rental property based in part upon a baseline income stream to the owner;
providing a property management platform, said property management platform configured to communicate over a network with the owner, the tenant, and a plurality of providers configured to provide goods or services to the tenant and/or the rental property;
defining an improved income stream from the tenant to the owner based upon an improved income stream, said improved income stream having a first component and a second component, wherein said first component of said income stream is derived from a rental obligation of the tenant; and said second component of said income stream is derived from the coordination, by said property management platform, of said plurality of providers.
